(19) United States
(12) Patent Application Publication
(10) Pub. No.: US 2010/0195906 A1
(43) Pub. Date: Aug. 5, 2010

(54) AUTOMATIC IMAGE ENHANCEMENT

(75) Inventors: Mithun ULIYAR, Bangalore (IN); A.G. KRISHNA, Bangalore (IN); P.S.S.B.K GUPTA, Bangalore (IN); Sirish Kumar PASUPALETI, Bangalore (IN)

Correspondence Address: Workman Nydegger;1000 Eagle Gate Tower, 60 East South Temple, Salt Lake City, UT, 84111, US

(73) Assignee: ARICENT INC., George Town (KY)

(21) Appl. No.: 12/365,078

(22) Filed: Feb. 3, 2009

(51) Int. Cl. G06K 9/40; G06K 9/00

(52) U.S. Cl. 382/167; 382/274

(57) ABSTRACT

Disclosed is a method for correction of pixel values of an input image to compensate for variation in image capturing conditions is proposed. In an embodiment, the method enables computing a statistical value from a selected set of pixel values associated with the input image. Based, at least in part, on the computed statistical value a set of parameter values is derived. The parameter values correspond to at least two gompertz functions. The method further enables applying the at least two gompertz functions to the input image to obtain an output image. This results in an output image with one or more corrected pixel values.

### FIELD OF THE INVENTION

The disclosed invention in general relates to the field of digital image processing, and more particularly, to a method for image enhancement to compensate for the variations in an input image under different image capturing conditions.

### BACKGROUND OF THE INVENTION

With advancements in digital image processing and digital image photography, point and shoot photography has become a norm more than a luxury. However, variations in image capturing conditions, typically, have an impact on the quality of the captured image. For instance, bad lighting conditions are a common phenomenon in digital photography (e.g. when photos are taken using a camera phone).

The various lighting problems associated with bad lighting conditions may include situations like low light condition, back-lit condition, High Dynamic Range (HDR) images condition, moving object conditions etc. Typically, low light condition occurs when the ambient lighting condition is not good enough to illuminate the scene, which is to be photographed. In a typical scenario, flash can be used for such low light conditions. However, this is not always feasible since (for example in a camera phone) a flash consumes huge power. Further, typically, back-lit condition occurs when the light source is behind the subject being photographed. In a typical scenario, such a condition occurs when the direction in which the light falls is not considered during photography. Furthermore, HDR images are those that have details in highlights and shadows. Because of the details in highlights and shadows (e.g., a dark room where there is a window open to sunlight) the images are typically improperly captured.

Thus, in this age of point and shoot digital photography, the image capturing conditions as stated above have an impact on the quality of the captured image. In particular, in one example, lighting problems associated with image capturing conditions deteriorates the quality of the captured image. Hence, to obtain good quality images, the captured image needs to be corrected. However, any solution technique designed for, for example, a digital camera or a camera phone needs to have satisfactory quality while also giving good computational performance so that the solution runs in real time. Thus, there is a requirement of an optimal solution that provides good quality with less complexity.

Typically, automatic techniques for correction of the captured image are being implemented. In particular, in an example, automatic lighting correction techniques are in the process of development to meet an amateur photographers needs. Typical automatic image correction techniques (e.g. retinex based techniques) provide an estimate of the lightness in a scene, i.e., the reflectance and lightness are estimated from the scene. The lightness component may be processed separately to for example, change the contrast or correct the white balance without affecting the scene reflectance. Thus, such techniques require computing of the lightness values and hence are computationally complex.

Another existing technique for automatic image enhancement includes a tone curve based technique. Tone curve based techniques, typically, involve determining the appropriate amount of correction or selection of the appropriate tone curve. An appropriate family of tone curves needs to be selected for image enhancement, and further a mapping between the tone curve parameter and scene statistics are derived. In particular, this, typically, involves applying a non-linear mapping to the input pixel values to achieve the desired result, for example, of either exposing the shadows or the highlights. Typical examples of such mappings are gamma function and log function. Tone curves are most useful in rendering HDR scenes on media that have a lower dynamic range. However, hue shifts and loss in saturation are common when tone curves are used.

Yet another existing technique for image enhancement is a histogram based technique. Typically, an image contrast can be gauged from its histogram. Histogram techniques involve modifying the histogram of the image to achieve the desired enhancement. Most popular is the histogram equalization, which when applied to an image, forces its histogram to resemble a uniform distribution. Adaptive histogram techniques perform significantly better than simple histogram equalization as they not only improve the global contrast but also the local contrast. Histogram techniques are conceptually simple, but global histogram techniques destroy local contrast while the local histogram techniques are computationally complex. As with tone curve's case, hue shifts and saturation problems can occur. Posterization artifacts are very common in histogram-based enhancement.

Still another existing technique for image enhancement is High Dynamic Range Imaging (HDRI). Natural scenes have a significantly higher dynamic range than what a conventional camera can capture or a conventional display device can render. HDRI techniques involve multiple images of the same scene taken with different exposures. Using multiple images of the same scene obtained using different exposures, a response function is determined to a scale factor. Given the response function and the exposure duration of each photograph, the radiance map can be constructed. Adopting this in a consumer camera to enhance images is difficult owing to the requirement of multiple images of exactly the same scene. Further, HDRI is most useful for stationary scenes, most commonly encountered scenarios are not stationary, i.e. there are subjects to be photographed moving about. The requirement of multiple exposures of strictly the same scene is rather limiting. In addition, the memory requirement for processing and storage of HDR images is high. Furthermore, HDRI techniques are not applicable for enhancing low light conditions.

Further, existing methods and systems employ an adaptive gamma processing technique to amplify the luminance of the dark pixels and preserve the contrast of the bright pixels, mainly for backlit images. Features are, typically, extracted from each input image and a neural network is trained to minimize the error between the automatically determined gamma and the manually specified gamma. However, color fidelity may not be ensured in the processed images.

Certain other methods include an automatic tone correction of images using non-linear histogram processing. In this method, tone curve is derived from the image histogram. Square root of the histogram is computed for dynamic range compression. This ensures that small histogram values have more contribution in the final tone curve while the large histogram values have lesser contribution. The resulting curve is smoothed and the tone curve is computed (cumulative distribution function normalized is the tone curve). For color images, three tone curves can be obtained from the three primary color channels or the tone curve estimated from luminance (defined as maximum of the primary colors at each pixel) can be used on the three-color channels. However, in such methods use of a fixed power for dynamic range compression is typically, sub-optimal. This may be so, as an image should ideally have a flat histogram, which is not the case with backlit or front lit images. Also, in some cases, excessive contrast enhancement in some regions causes objectionable artifacts in the image.

Still other methods include adaptive exposure correction techniques using, for example, a camera response like function. This method can be applied for Bayer images as well. However, such methods necessitate computational complexity involving logical operations, basic, semi-complex and complex arithmetic operations and complex designing of the associated hardware for implementation thereof.

Certain other methods include image contrast enhancement using intensity-pair distributions. Given an image, a set of expansion and anti-expansion forces are computed based on the intensity pairs at each pixel. The expansion forces serve to increase the contrast and the anti-expansion forces suppress noise. It has been found that selection of threshold used with intensity differences has a significant effect on the performance of the methods. If the threshold is very low, noise is not sufficiently suppressed while if the threshold is high, over smoothing occurs. Also, the number of pixels used to construct the mapping function is an issue since using all the pixels in the image might not be required.

Further, the state of the art techniques associated with image correction/enhancement, typically, introduce a haze after enhancement or a grey tinge to the image. This is more prominent in case of retinex based methods when correcting low light images. Also proper preservation of the highlight details is a problem in case of some of the known techniques.

Hence, there is a need to provide a method that renders an optimal solution for correction of captured images at a reduced complexity that provides images with very high subjective quality in a real time scenario.

### SUMMARY OF THE INVENTION

Embodiments of the present invention are directed to methods for image correction. In particular, embodiments of the present invention enable automatic correction of images when captured under conditions that affect the quality of the captured image.

Accordingly, a method for correction of pixel values of an input image to compensate for variations in image capturing conditions is proposed. In an embodiment, the method includes computing a statistical value from a selected set of pixel values associated with the input image. Based, at least in part, on the computed statistical value a set of parameter values is derived. The parameter values correspond to at least two gompertz functions. The method further includes applying the at least two gompertz functions to the input image to obtain an output image. This results in an output image with one or more corrected pixel values.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 schematically illustrates an example of a system that may implement the principles of the present invention.

FIG. 2 schematically illustrates an example process for correction of pixel values of an input image in accordance with an implementation of the present invention.

FIG. 3 illustrates an example flow chart that depicts correction of pixel values of an input image in accordance with yet another implementation of the present invention.

FIG. 4 illustrates a graph of modified gompertz function for a particular computed mean value of G plane according to an embodiment of the present invention.

FIG. 5 illustrates a graph of modified gompertz function for another particular computed mean value of G plane in an RGB color space according to another embodiment of the present invention.

FIG. 6 illustrates a graph of modified gompertz function for yet another computed mean value of G plane in an RGB color space according to yet another embodiment of the present invention.

### DETAILED DESCRIPTION OF THE INVENTION

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

In a digital photography scenario, various digital image-capturing devices such as camera phones, digital cameras, portable media players, digital photo frames, or the like are widely used. Further, with advancements in digital photography and digital image processing point and shoot digital photography has become a norm for amateur users. Accordingly, in such a scenario, the quality of image captured by the various image-capturing devices is of major significance.

For instance, most modern day cameras have an elaborate image pipeline, which determines the quality of the image captured. Though not a part of the basic image pipeline, lighting correction is a very important module that can have enormous bearing on the overall image quality. In addition, one of the main problems affecting the subjective quality of the image arises due to an incorrect exposure. Though, fairly sophisticated auto exposure modules are used in the modern cameras, the chances of the auto exposure module computing a wrong exposure are fairly high, especially when the lighting of the scene that is to be photographed is non-ideal.

In particular, typically, quality of an image captured is subject to varying conditions and settings under which the image is captured. For instance, unfavorable lighting conditions impact on the quality of the captured image (also referred as output image throughout the disclosure). In particular, the various lighting problems may occur due to low light condition, back lit condition, High Dynamic Range (HDR) images. Low light happens when the lighting condition is not enough to illuminate the scene. For example, lowlight images occur when an image is captured indoors without a flash or with a weak flash or outdoors at night. Further, it may be appreciated that generally, cameras in phones, compact digital cameras and other handheld image-capturing devices are provided with a baseline ISO setting (ISO measures sensitivity of image sensor in a camera). Such devices cannot have very long exposures because of handshakes and motion blur. Besides, a long exposure is inconsequential without a tripod. Therefore, the camera increases the ISO setting. Consequently, the increase in the ISO setting results in an increase in noise (aberrations like granularity in the captured image), which is undesirable.

Thus, images captured under low light conditions as mentioned hereinbefore, need to be corrected to get the desired output image. Correction of lowlight images implies contrast enhancement without amplifying noise. This is an extremely challenging problem, more so with camera phones, where noise is significantly high. Existing systems and methods exist for correction for lighting correction of input image, however with certain limitations. For instance, the existing systems and methods do not process or reduce noise, rather, in most cases, noise increases during contrast enhancement. Thus, post processing of the input image to correct low light image, there remains a requirement to denoise the output image using a high quality technique for removal of noise. This contributes to the complexity of the existing lowlight correcting technique.

Further, backlit happens when the light source is behind the subject being photographed. In a typical scenario, if the background is brighter than the foreground/subject as can happen in photos where there is water, snow or sand, the subject will appear very dark against the bright background. Backlit images are possibly the most common cause of outdoor photos not being of a good subjective quality.

Furthermore, HDR scenes are those that have details in highlights as well as shadows and scenes that have a very high contrast. For e.g., a dark room where there is a window open to sunlight. Such scenes are difficult to meter. This is so, as the dynamic range of natural scenes is, typically, higher than that of the image-capturing device (e.g, camera). As such, either the shadows or the highlights will be improperly rendered.

Existing systems and methods apply auto exposure modes to correct the backlit image and HDR images. However, such auto exposure modes, in certain instances, are unable to meter backlit scenes correctly resulting in photographs where the foreground is dark and background is bright. In particular, in such instances, auto exposure units of, for example, cameras, can sometimes be misled into a wrong decision leading to an incorrect exposure. This happens most commonly when the scene has details in the shadows as well as the highlights. A typical example is the scene of the interiors of a dark room that has a window open to bright sunlight. If the exposure is optimized for details near the window, the interiors of the room, which is dark, will be completely black. On the other hand, if the exposure is increased to expose the details in the interiors of the room, then the details near the window will be washed out as a result of pixels of the image captured being saturated. In these kinds of cases where there is no single optimal exposure value, the auto exposure unit expectedly fails.

It may be appreciated that there is no definition of what an ideal exposure is. It can be thought of as that exposure which ensures that an optimal amount of detail is present in shadows as well as highlights. In particular, image tone rendering has to be pleasing to human perception without significant shadow regions where no detail is visible and also without the highlights being saturated.

Typically, professional photographers use manual techniques to set the optimal exposure for a given scene. The auto exposure unit of a camera is expected to ideally mimic a professional photographer. However, due to several constraints, the auto exposure unit, particularly in compact cameras and camera phones cannot employ extremely sophisticated techniques and hence the metered value is often far from ideal, resulting in an unpleasant picture. Consequently, it is highly desirable to have an option of correcting the image after it has been captured. Certain existing systems and methods use exposure bracketing to improve the image quality during capture. However, an automatic enhancement technique is preferred over a manual technique [exposure bracketing] to change the exposure. Further, in addition to enhancing the lighting in a scene, it is of critical importance to ensure that the colors are rendered as faithfully as possible.

Thus, the existing techniques for correction of captured images have certain limitations in terms of requirement of manual procedures, computational complexities, image artifacts, and certain constraints in cases of moving subjects. Methods and systems are disclosed for enhancing images captured under various image-capturing conditions that address one or more drawbacks of the existing systems and methods. In an implementation, the disclosed methods and systems correct images captured under non-ideal lighting with reduced complexity and in a real time scenario. In particular, in an exemplary embodiment, the proposed approach corrects contrast problems (low contrast/flare) and brightness problems associated with the captured image.

Embodiments of the invention relate to methods and systems for correction of pixel values of a digital input image (also referred as input image) captured by image-capturing devices. It may be appreciated that image-capturing devices are inter alia constituted of image sensors and color filter arrays (CFA) that are typically arranged on square grids of the image sensors. In general, there are different kinds of color filter arrays, for example 3 color CFAs typically using RGB or CMY and 4 color CFAs typically using CMYK or RGBE etc. It will be understood that the layouts of the pixels (i.e. the basic repeating unit of the digital image) can be different. For purposes of ongoing description, the proposed approach is illustrated using Bayer CFA. It will be understood that Bayer CFA refers to RGB CFA with the basic repeating unit consisting of two greens, one red and one blue as shown below.

| | |
|---|---|
| Green | Red |
| Blue | Green |

It may be appreciated that CFAs sample one color at each pixel, for example, the Bayer CFA samples three colors—red, blue and green all over the image sensors, sampling green at twice the rate of red and blue. Each pixel, therefore, has information of only one color.

In an example implementation, lighting correction of the input image is disclosed. The proposed approach is based on modification to the gompertz function (also known as gompertz curve). It may be appreciated that, conventionally, the gompertz curve is a sigmoid function given by the following equation.

y=ae^{be} ^{^{cx}}

where x is the input pixel value and y is the output value, a and b are constants.

As may be understood to a person of ordinary skill in the art, the gompertz function is a type of mathematical model for a time series, where growth is slowest at the start and end of a time period.

According to the principles of the present invention, one or more modified gompertz function(s) (according to the proposed approach) is applied on the captured input image for correction of the pixel values of the input image. In an example implementation, the present invention proposes blending of at least two gompertz functions for image enhancement, which is given by the following equation.

y=e^{ae}^{^{bx}}+e^{ce}^{^{dx}}

It may be noted that x is the input image's pixel value and y is the corrected pixel value of the output image. a, b, c and d are set of parameter values of the gompertz functions that are set based on certain statistics of the input image that is being processed. Constants of the parameter values are computed for the input image based on certain criteria (to be discussed in detail in sections below). Further, it may be noted that this approach can be efficiently implemented by using a look up table (LUT), which is computed once and stored for further processing. It may be noted that certain enhancements can be obtained using a single gompertz function. In addition, the principles of the present invention may also be applied using more than two gompertz functions.

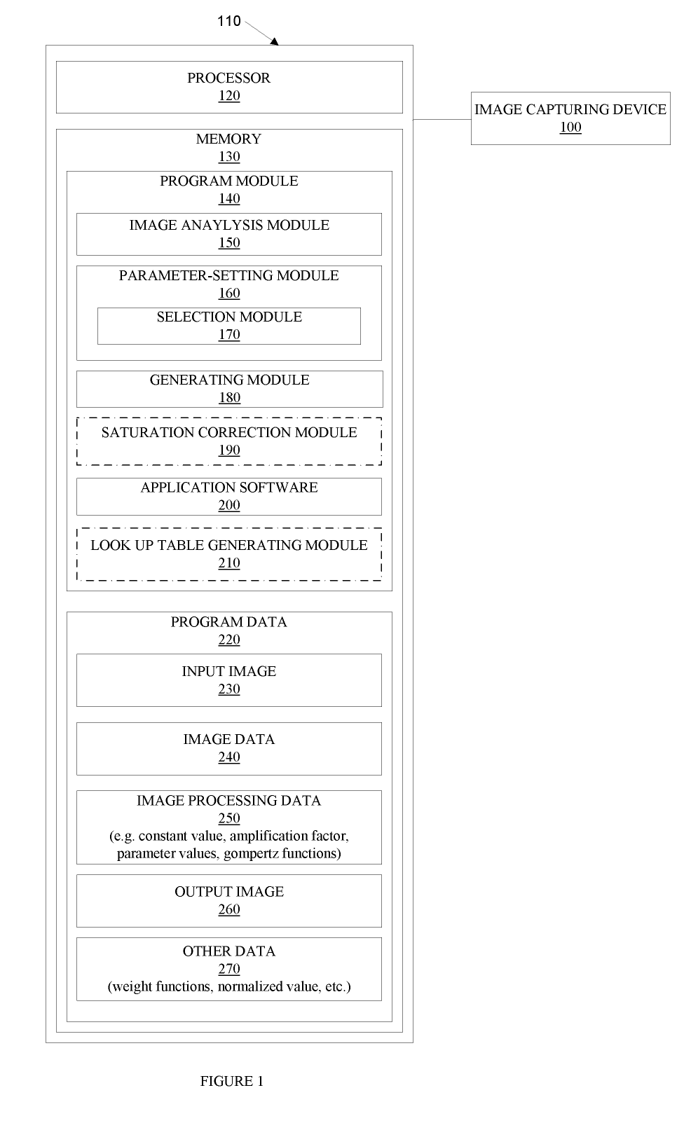

FIG. 1 shows an example of a system 110 that may implement the principles of the present invention. In an embodiment, the system 110 may be a camera phone, a digital still camera, a portable media player, a digital photo frame, a camcorder and the like. The system includes a processor 120 coupled to a memory 130 storing computer executable instructions. The processor 120 accesses the memory 130 and executes the instructions stored therein. The memory 130 stores instructions as one or more program modules 140 and associated data in program data 220. The program data 220 stores all static and dynamic data for processing by the processor 120 in accordance with the one or more of the program modules 140.

It may be noted that the system 110 is associated with an image-capturing device 100. For practical applications, the system 110 may be integral to the image-capturing device 100. The system 110 may also be available as an external kit for use with an image-capturing device 100. As previously stated, in such a case, the image-capturing device 100 can be any of a camera phone, a digital still camera, a portable media player, a digital photo frame, a camcorder and the like. It may be noted that typically, in image capturing applications, the system 110 may be implemented as a pre-processing system for image quality enhancement with reduced complexity in accordance with the principles of the present invention. In addition, the system 110 may also be used as a post-processing system for image quality enhancement in accordance with the principles of the present invention. The post-processing system may be embodied for image quality enhancement in, for example, an image viewer, an image editor, and the like. However, as mentioned previously, the principles of the invention may be implemented in any suitable hardware or software architectures and is not restricted to those described in the disclosure.

As shown in FIG. 1, in an implementation, the program module 140 includes an image analysis module 150. In operation, the image-capturing device 100 captures an image and the system 110 receives and stores the same as input image 230 in program data 220 for further processing. It may be appreciated that the input image 230 constitutes the image that is captured by the image-capturing device 230. Subsequently, the input image is processed by the image analysis module 150 for computation of a statistical value of the pixel values constituted in the input image. In particular, the image analysis module 150 is configured to compute a statistical value from a selected set of pixel values associated with an input image. The statistical value thus obtained is stored as image data 240 in the program data 220. The image data 240 stores information relating to image characteristics (such as brightness, contrast etc.) and computed statistical values.

In this implementation, as mentioned previously, the proposed approach is based on working in the RGB color space domain (also referred as Bayer CFA) and the selected pixel values correspond to the green band of the input image 230. In an example, the statistical value is computed as a mean value of the green band and stored in the image data 240. It may be noted that from the computed mean value the extent of lighting in the input image can be determined. It may be appreciated that mean value of the green band may be specifically chosen as the green band represents the luminance in the scene to be photographed (captured as input image 230 ). It may be further appreciated that brightness is an image characteristic that is dependent more on the luminance of the scene to be photographed. It may be noted that the statistical value can be computed as any other quantity other than mean for determining the extent of lighting of the captured image.

Subsequently, the statistical value thus computed, is used to derive the set of parameter values of the gompertz function that is modified in accordance with the proposed approach. The gompertz function(s) is stored as image-processing data 250 for further processing by the processor 120 in accordance with one or more program module(s)140. As mentioned previously, in an example implementation, at least two gompertz functions are considered and a, b, c and d are the parameter values of the gompertz functions. Referring to FIG. 1, the program module 140 includes a parameter-setting module 160. The parameter-setting module 160 is configured to process the statistical value stored in the image data 240 to derive parameter values of the gompertz functions. It may be noted that since the derived parameter values of the modified Gompertz curve is based on the image statistics (derived from computed statistical values), the proposed approach is an adaptive one. As shown in FIG. 1, the program module includes image-processing data 250 that stores data for processing the input image by the program module 140. Accordingly, parameter values thus calculated is stored in the image-processing data 250 of the program data 220 for further processing of the input image 230.

In yet another implementation, the parameter-setting module 160 further includes selection module 170 to select constant values for deriving the parameter values. In this implementation, the constant values are stored in the image-processing data 250. The selection module 170 thus processes the selection of the constant values based on certain criteria (as discussed in the below sections). The program module 140 further includes a generating module 180. In this implementation, the generating module 180 is configured to generate an output image 260 with the corrected pixels values. As shown in FIG. 1, the output image 260 is stored in the program data 220. It will be appreciated that the output image 260 can be rendered in a display (not shown) of the image-capturing device 100. In this implementation, the generating module 180 is configured to apply the at least two gompertz functions to the input image 230 to obtain an output image 260. It may be appreciated that the generating module 180 may also be configured to apply one or more gompertz functions modified in accordance with the present principles. It may be noted that typically corrected pixels correspond to correction of one or more image characteristics of the captured input image 230. As discussed previously, the image characteristics correspond to brightness, contrast, and other image characteristics stored as image data 240 in the program date 220.

Herein below is an exemplary equation that illustrates the constant values selected in accordance with an embodiment of the present invention.

### EXAMPLE

As discussed previously, the equation for the modified at least two gompertz functions is

y=e^{ae}^{^{bx}}+e^{ce}^{^{dx}} \textcircled{1}

where x is the input image's pixel value and y is the output image's pixel value (corrected image) and a, b, c and d are parameter values. The following is an example equation for derivation of the parameter values of the gompertz functions.

$$\begin{matrix}a = - 80 * {lMean}^{- 0.95} & b = - 200 * {lMean}^{- 0.65} \\ c = - 10 & d = - 5\end{matrix} \qquad ◯ 2$$

In this example, the parameter a governs mainly the contrast of the output image and parameter b governs mainly the brightness of the output image. As will be understood by a person skilled in the art, contrast is the difference between the bright portion of the image to the dark portion. One of the statistical values that can be used to determine the amount of contrast needed in the output image 260 is the mean value of the input image 230. As discussed previously, in this example, mean value of the green band (as shown in FIG. 1, the mean value is stored in image data 240 of the program data 220 ) of the input image 230 is computed.

It may be noted that the selection module 170 selects the constant values stored in the image-processing data 250 of the program data 220 such that the set of parameter values lie in a predetermined region defined by the one or more gompertz functions. As shown in the exemplary equation above, the constant values −80 and −0.95 are selected to ensure that the parameter a varies in the region −1 to −5 of the at least two gompertz functions. It may be noted that, in an implementation, the selection of the constant values also depend upon the computed mean value of the input image 230. It may be further noted that, in an implementation, the constant values may be chosen empirically so as to get a proper shape of the gompertz functions (curve shape).

The values illustrated in the above exemplary equation are so chosen considering a condition that the input image 230 is a dark image. It may be understood by a person of skill in the art that, in such a case, the amount of contrast should also be more so as to prevent the appearance of haze effect in the output image 260. The parameter a (derived as per the above equation) in the gompertz function, which largely governs the contrast, increases the contrast of the output image 260 when the computed mean value is less, and vice versa.

Further, as discussed above, the parameter value b mainly controls the brightness of the output image 260. In this case, as well, one of the statistical values that can be used to determine the amount of brightness needed in the output image 260 is the mean value of the input image 230. As discussed previously, in this example, mean value of the green band (as shown in FIG. 1, the mean value is stored in image data 240 of the program data 220) of the input image 230 is computed.

As in the case of parameter b, it may be noted that the selection module 170 selects the constant values stored in the image-processing data 250 of the program data 220 such that the parameter value b lie in a predetermined region defined by the one or more gompertz functions. As shown in the exemplary equation above, the constant values −200 and −0.65 are selected to ensure that the parameter b varies in the region −10 to −40 of the at least two gompertz functions. It may be noted that for most of the input images 230, the parameter b is expected to range from −10 to −40, with less value indicating more brightness. The constants in the above equation are so chosen so as to make the parameter b fall in this region.

The parameter setting module 160, thus, derives the set of parameter values and stores the same in the image-processing data 250 in the program data 220 for further use by one or more of the program modules 140 (e.g. generating module 180 ). Hence, using the computed mean value of the input image 230 it is possible to determine the amount of correction needed to be performed to obtain a good contrast and brightness adjusted output image 260. Also, as discussed previously, the selection of the constant values by the selection module 170 to derive the parameter values is based on getting the proper range in the gompertz functions.

Thus, in an implementation, the gompertz functions (modified) that are generated for different input images 230 are obtained by blending the at least two gompertz functions (according to this example implementation) having a set of the derived parameter values. The generating module 180, thus, applies the modified gompertz function(s) stored in the image-processing data 250 to generate the output image 260. It may be noted that one set of parameter value gives the handle to vary the lower end of the color values and the other set of parameter values (corresponding to the other gompertz function) for the higher end of the color values. Such a designing of the proposed approach ensures generation of high quality output image 260 by the generating module 180.

In a further implementation, during the process of blending of the gompertz functions, weight functions may be assigned to the gompertz function(s). The example equation hereinbelow illustrates the assignment of the weight functions.

y=w₁e^{ae}^{^{bx}} ^{N}+w₂e^{ce}^{^{dx}}^{N} \textcircled{3}

In this implementation, the weights w₁ and w₂ may be set to equal values (e.g 0.5.). Thus, indicating equal weights are assigned to both the gompertz functions in the process of blending. In the case of an HDRI input image 230, the first and the second gompertz curves obtained, in accordance with the description above, ensures that the shadows are enhanced and highlights are properly rendered respectively. In this implementation, the weight function may be stored in the program data (indicated as other data 270).

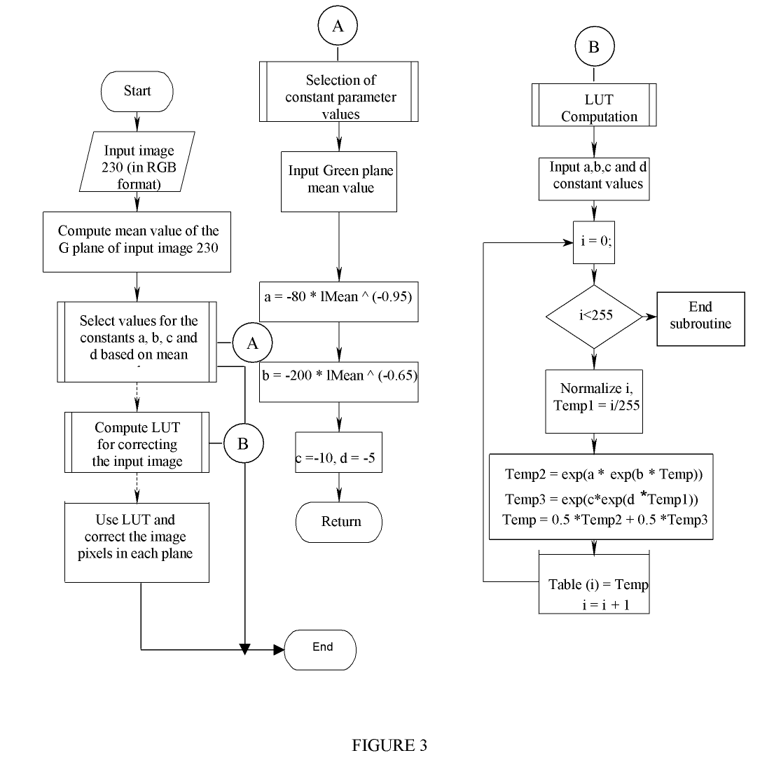

Alternately or additionally, the program module 140 may include a look up table (LUT) generating module 210. The look up table generating module 210 is configured to generate a look up table for storing the computed statistical values, as discussed above. In particular, in an implementation, the LUT computation subroutine runs only 255 values (to be discussed later with referenced to FIG. 3) and stores the values in the LUT table. Thus, the resulting computation is only a simple look up table.

Additionally, the program module 140 may also include a saturation correction module 190. It may be appreciated that the saturation correction module 140 may be stored in a repository external to the system 110 and is functionally connectable to the system 110. As discussed previously, perceivable haze in the output image 260, which is typically encountered in the existing methods and systems, is not present. However, in an instance, color saturation in the output image 260 may be reduced (also referred as desaturation). This is perceivable if the output image 260 has highly saturated primary colors. It may be appreciated that as important as details are to human visual perception, equally important is the color fidelity, i.e. hue and saturation must remain intact. It will be understood by a person of skill in the art that, for example, any aberration in skin color, blue in the sky and green in foliage are easily perceived. Traditional methods, address the desaturation problem by working in the hue saturation value (HSV) space wherein the V component is processed for lighting correction while saturation component is left untouched. This results in complexity involved in conversion to non-linear spaces. The proposed approach corrects the color saturation problem and works on the RGB color space. In other words, the proposed approach for saturation correction is implemented in linear color spaces to avoid the complexity involved in the conversion to non-linear color spaces.

Accordingly, saturation correction module 190 is configured to perform saturation correction on the input image 230. In an implementation, in particular, the saturation correction module 190 is configured to apply an amplification factor on all the pixel values of the input image 230. Before computing the amplification factor, the color band having the maximum among the R, G, B values of the input image 230 pixel is determined. The amplification factor is obtained by computing the ratio of the value of the pixel corresponding to the color band determined previously in the output image 260 and the corresponding color band value of the pixel in the input image 230. The amplification factor, thus computed, is applied to all the color bands of the pixel of the input image 230 after applying the gompertz function(s) to the input image 230. The amplification factor is determined for each pixel of the input image 230 separately. The program module 140 further includes other application software (operating system) 200 required for the functioning of the system 110.

Thus, the proposed approach performs tone curve correction and image blending of the input image 260 to obtain the corrected output image 260. To accomplish this, as discussed previously, from the input image 230, two images are derived, one of which has details in the shadows revealed and the other in which the details in the highlights are optimally revealed. The given image is assumed to have details in the mid-tones. Based on this assumption, the two images are combined such that optimal detail is revealed all over the image with minimal color shifts and other artifacts.

Conventionally, for example, high dynamic range imaging involves combination of multiple images to give an image that has details revealed in the shadows as well as the highlights. The multiple images are exposed in such a way that details of all the areas are exposed optimally in at least one of the images. In contrast, the proposed approach uses a single image. In an implementation, the proposed approach is based on working in the RGB color space domain. As such, the enhancement is to be applied to each of the color channels, though the parameter values are kept constant across the channels once they have been determined. In other words, for each of the color channels (example, R, G, B), the derived parameter values a, b, c, and d of the modified gompertz function remains the same. In particular, the parameter values determined from the mean value of the green band are used for the red and blue bands also. However, it may be noted that determining parameter values from a, b c and d from statistical values of the color bands (example, red and blue) separately is also possible. As mentioned previously, it is to be noted that the proposed approach can be extended to other color spaces, such as CMY, CMYK, RGBE and the like.

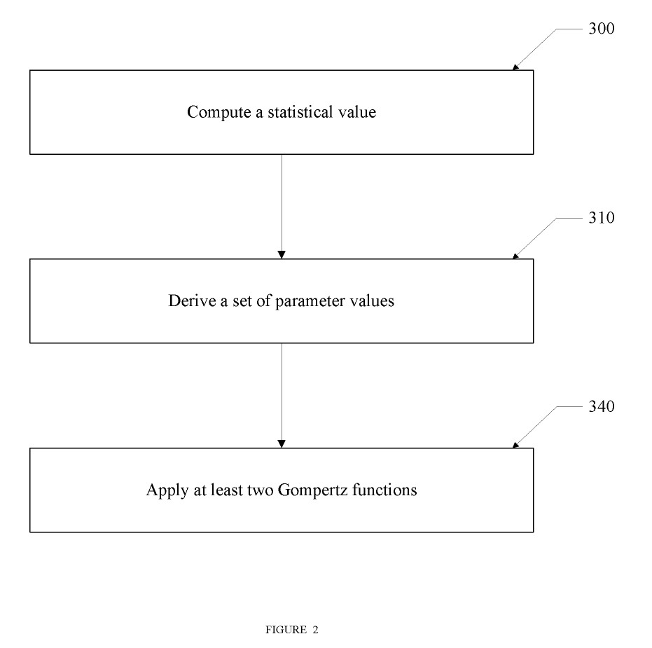

FIG. 2 illustrates a process 300 for correction of pixel values of an input image 230 in accordance with an implementation of the present invention. Description of the process 300 is with reference to FIG. 1 described previously. At step 300, a statistical value is computed. In an implementation, the image analysis module 150 computes a statistical value (e.g. a mean value) of the selected set of pixel values of the input image 230. In this implementation, as mentioned previously, the proposed approach is based on working in the RGB color space domain (also referred as Bayer CFA) and the selected pixel values correspond to the green band of the input image 230. In operation, the image data 240 stores the statistical value (e.g. mean value) of pixel values that correspond to the green band. From the computed mean value the extent of lighting in the input image 230 can be determined. It may be appreciated that mean value of the green band may be specifically chosen as the green band represents the luminance in the scene to be photographed (captured as input image 230). It may be further appreciated that brightness is an image characteristic that is dependent more on the luminance of the scene to be photographed. It may be further noted that the statistical value can be computed as any other quantity other than mean for determining the extent of lighting of the captured image.

At step 310, a set of parameter values is derived. The set of parameter values correspond to one or more gompertz function(s) stored in the image processing data 250. In operation, the parameter-setting module 160 derives the set of parameter values using the data stored as image-processing data 250. In an implementation, the parameter values (e.g. a, b, c and d as depicted in equation 1) correspond to at least two gompertz functions. In this implementation, based on the computed mean value of the pixel values that correspond to green band of the input image 230, the parameter values are derived (as depicted in equation 2). Further, in this implementation, constant values (stored in the image-processing data 250) are selected to derive the parameter values. The selection module 170, in an example, embodied in the parameter-setting module 160 operates in conjunction with the information stored in the image-processing data 250 to select the appropriate constant values based on certain criterion.

In particular, as depicted in equation 2, the constant values are chosen suitably such that the parameter values lie in a predetermined range of the gompertz function(s). As mentioned previously, parameter value a mainly governs the contrast of the output image 260 and parameter value b governs the brightness of the output image 260. Accordingly, in an embodiment, the predetermined range may lie in the range of about −1 to about −5 of the gompertz function for parameter value a. According to yet another embodiment, the predetermined range may lie in the range of about −10 to −40 for parameter value b.

At step 340, one or more gompertz functions are applied to the input image 230. In particular, the gompertz function(s) obtained by steps 300 and 310 results in a modified gompertz function(s) (stored as image processing data 250). In operation, the modified gompertz function(s) is applied to the input image 230 by the generating module 180 to obtain an output image 260. The output image 260 constitutes one or more corrected pixel values. In other words, the corrected pixel values correspond to corrected image characteristics such as contrast, brightness etc of the output image 260. The image characteristics of the input image 230 such as contrast, brightness etc. is stored as image data 240. Operationally, in an implementation, the generating module 180 communicates with the image data 240 and image-processing data 250 to carry out the application of the modified gompertz function(s) to the input image 230.

In an embodiment, where at least two gompertz function(s) are used, weighted function(s) are defined to the at least two gompertz functions. In an example, equal weights (0.5) are assigned to the at least two gompertz functions (as depicted in equation 3). In operation, the generating module 180 applies the weighted functions stored as other data 270 in the program data 220 to the at least two gompertz functions during the process of blending of the two gompertz functions. In the case of an HDRI input image 230, the first and the second gompertz curves obtained, in accordance with the description above, ensures that the shadows are enhanced and highlights are properly rendered respectively.

Further, in an implementation, the selected set of pixel values of the input image 230 may be normalized. For example, to obtain the corrected pixel value of the selected set of pixel values that correspond to green band of the input image 230, the input pixel value x (as depicted in equation 3) is normalized between the range 0 to 1 (shown below).

$${x}_{N} = \frac{x}{255}$$

Subsequently, the value x_{N} (normalized value) may be substituted into the modified gompertz function(s) to get the corrected output pixels. For example, equation 4 as depicted below.

y=w₁ e^{ae}^{^{bx}}^{N}+w₂e^{ce}^{^{dx}}^{N} \textcircled{4}

The final output pixel values are then multiplied with a value of 255 to get back the actual corrected pixel value. In operation, the generating module 180 operates in conjunction with the normalized value, thus computed and stored as other data 270 to generate the modified gompertz function. The modified gompertz function is then applied to the input image 230 to obtain the corrected output image 260. FIG. 3 illustrates an example flow chart that depicts correction of pixel values of the input image 230 in accordance with yet another implementation of the present invention.

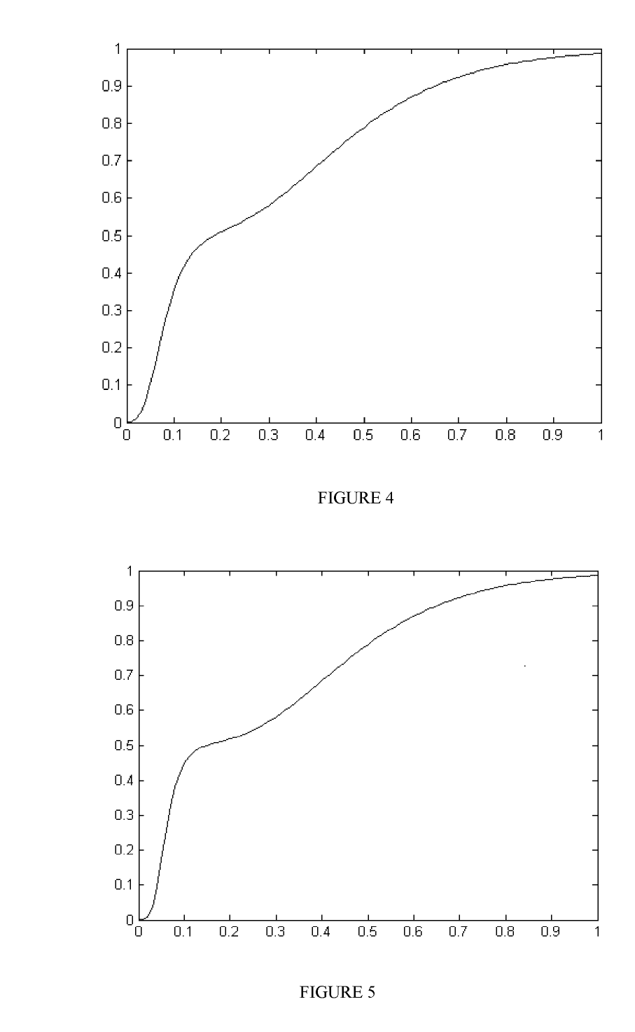

Alternately, in a still further implementation, a look up table (LUT) is generated for storing the computed modified gompertz function output value. In an implementation, since, for an 8 bit input image 230 the image values can range only from 1 to 255, the output of equation 4 is pre-computed for these 255 values and then for obtaining the output image 260 a simple mapping from the LUT is used. In operation, the look up table generating module 210 is configured to generate the LUT. It can be observed from FIG. 3, that the LUT computation subroutine runs only the 255 values and stores the values in a table. As such, the computation is only a simple look up table and reduces further the computational complexity. It will be appreciated that in case of an input image 230, for example an HDR image processed in accordance with the present invention, the output image 260 will have shadows significantly enhanced without washing out the highlights. This is due to the fact that, as shown in exemplary FIG. 4, initially the modified gompertz curve rises slowly before picking up the slope. The graph in FIG. 4 is illustrated with parameters a=−7, b=−30, c=−11 and d=−6.

Additionally, in an implementation, saturation correction is performed. In particular, saturation correction is performed on the input image 230. In an implementation, the saturation correction is performed on all the pixel values that correspond to the input image 230. As discussed previously, desaturation of the input image 230 may occur and that this is perceivable, especially, if the output image 260 has highly saturated primary colors. It may be appreciated that as important as details are to human visual perception, equally important is the color fidelity, i.e. hue and saturation must remain intact. It will be understood by a person of skill in the art that, for example, any aberration in skin color, blue in the sky and green in foliage are easily perceived. Traditional methods, address the desaturation problem by working in the hue saturation value (HSV) space wherein the V component is processed for lighting correction while saturation component is left untouched. This results in complexity involved in conversion to non-linear spaces. The proposed approach corrects the color saturation problem and works on the RGB color space. In other words, the proposed approach for saturation correction is implemented in linear color spaces to avoid the complexity involved in the conversion to non-linear color spaces.

In operation, the program module 140 may also include a saturation correction module 190. It may be appreciated that the saturation correction module 140 may be stored in a repository external to the system 110 and is functionally connectable to the system 110. Accordingly, in an implementation, the saturation correction module 190 performs saturation correction by applying an amplification factor on the selected set of pixel values to obtain the corrected pixel values. In particular, the amplification factor represents an inverted ratio of the maximum value amongst the selected set of pixel values of the input image 230 and the corresponding pixel values of the output image 260. As shown in FIG. 1, in an implementation, the amplification factor is stored as image-processing data 250 and is applied to the pixel values that correspond to green band of the input image 230 subsequent to applying the one or more gompertz functions. Thus, in an implementation, weighted amplification and/or weighted attenuation may be performed on the selected set of pixel values.

An example approach for saturation correction is illustrated in the following example. In this example, the RGB triplet (of the input image 230) is considered as (109,36,1) which turned out to be (159,86,51) after enhancement in accordance with the proposed approach. It can be seen that the saturation dropped from 0.99 to 0.68. The amplification factors for the triplet is (1.46,2.39,51). Clearly, the blue gain is very high. As explained earlier, this is the reason for loss of saturation. In an implementation of the proposed approach for saturation correction, maximum pixel value of the input image 230 (denoted as m) is determined. Similarly, maximum pixel value of the output image 260 (denoted as M) is determined. The amplification factor is determined by obtaining a ratio of m and M.

In other words, in this implementation, the pixel value before enhancement is denoted as rgb and the pixel value after enhancement is denoted as (RGB). The maximum among rgb is denoted by m. The value among the corresponding color in RGB is denoted by M. It may be noted that m and M will almost always be the same color. The amplification factor (denoted as a) is determined as a=M/m. The amplification factor is then applied on (rgb) to obtain the corrected image pixel (output image 260).

In the example as afore-mentioned, m=109 which is the red pixel and M=159. The gain a=1.46. Therefore, the pixel RGB values after enhancement are (109×1.46, 36×1.46, 1×1.46) which is (159, 53, 1) after rounding. The saturation value is 0.99, thus retained intact. Thus, the proposed method for saturation correction is extremely simplistic and renders optimal the result.

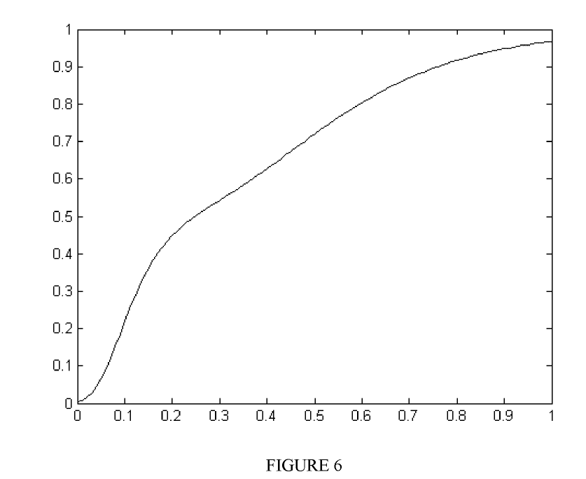

FIGS. 4 to 6 illustrates graphs of modified gompertz function for computed mean values of G plane in an RGB color space according to an embodiment of the present invention. It may be noted that in this illustration FIG. 5 is depicted with parameter value a=−10, b=−45, c=−11, d=−6 and FIG. 6 is depicted with parameter values a=−5, b=−18, c=−10, d=−5. It can be observed from the graphs that the curve increases rapidly for images whose average mean value is very less. This situation occurs usually in a low light condition, after the initial rise the graph takes a linear nature for higher values of the input pixels. If the mean value is high, this indicates a normally lit image or even a backlit image. For such cases, the correction is done minimally so as to preserve the input image 230 and the rise of the curve at the beginning is more measured compared to the previous cases. It may be noted that saturation correction is applied on all the images. By applying saturation correction, the present technique preserves the color content of the input image 230 in the output image 260 after the application of the modified gompertz function.

Advantageously, as mentioned previously, the image enhancement or lighting correction of the present invention improves the image quality subjectively over the existing techniques. As mentioned previously, a low light condition is considered, where the images appear dark, there is not much detail, contrast is poor, the image may be dark because of low light or having no flash or having a weak flash. In the existing techniques for correcting low light conditions, either the output image is rendered quite hazy or suffers from loss of saturation. Certain techniques also slightly over enhance the images.

Further, in case of backlit condition in which the foreground/subject is illuminated from the background, the foreground appears dark against a bright background. The existing techniques like auto exposure modes in most instances are unable to correct the backlit defect. Certain other techniques, such as the histogram based techniques do not render a good subjective quality and perceivable haze effect is also prevalent.

Furthermore, high dynamic range images have also been discussed above, where scenes having detail not only in the shadows but also in the highlights are very difficult to meter for exposure. As a result, the existing techniques, such as auto exposure unit cannot reveal details both in the shadows and highlights. In certain other techniques, the color saturation is reduced. In addition, in certain existing techniques color saturation may be satisfactory, however, may lack in brightness. Still other techniques yield images that lack brightness, are oversaturated, desaturated, or hazy. In contrast, the present approach advantageously renders the output image 260 by preserving colors and enhancing shadows in a subjectively pleasing manner.

Still further, the proposed approach advantageously ensures that if the method is applied on an image that requires little or no enhancement, the quality of the image is not severely degraded. Furthermore, it may be appreciated that images having a large amount of skin tone are extremely sensitive to any image enhancement technique used. Getting skin tone colors correct is critical for an image enhancement technique as human perception is very sensitive to variations in skin colors. An important aspect of any image enhancement technique is the way it handles images that do not need to be enhanced. Ideally, there should be a quantifiable method of determining how ‘perfect’ an image is, so that such images need not be processed. Determining the subjective quality of an image from different points of view such as lighting, noise, sharpness is a challenge. To this end, the present approach ensures that the way it changes an image that does need enhancement is not objectionable.

Certain existing techniques render a bluish tint, in the kind of images that involve skin color, color of eye etc. that are sensitive to human perception. Thus, use of such techniques, in certain instances, degrades the quality of the image and is not very robust. To this end, the proposed approach ensures that the skin is properly rendered and the eyes are visible. In case of still further techniques, the output image may be a bit over enhanced, may look artificial and may not have sufficient brightness, hence objectionable. In contrast, the proposed approach renders image of improved subjective quality with reduced complexity.

It will be appreciated that the teachings of the present invention can be implemented by hardware, executable modules stored on a computer-readable medium or a combination of both. The executable modules may be implemented as an application program comprising a set of program instructions tangibly embodied in a computer readable medium. The application program is capable of being read and executed by hardware such as a computer or processor of suitable architecture. Similarly, it will be appreciated by those skilled in the art that any examples, flowcharts, functional block diagrams and the like represent various exemplary functions, which may be substantially embodied in a computer readable medium executable by a computer or processor, whether or not such computer or processor is explicitly shown. The processor can be a Digital Signal Processor (DSP) or any other processor used conventionally capable of executing the application program or data stored on the computer-readable medium.

The example computer-readable medium can be, but is not limited to, random access memory (RAM), read only memory (ROM), compact disk (CD) or any magnetic or optical storage disk capable of carrying application program executable by a machine of suitable architecture. It is to be appreciated that computer readable media also includes any form of wired or wireless transmission. Further, in another implementation, the method in accordance with the present invention can be incorporated on a hardware medium using ASIC or FPGA technologies.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

We claim:

1. A method for correction of pixel values of an input image to compensate for variation in image capturing conditions, the method comprising:
computing a statistical value from a selected set of pixel values associated with the input image;
deriving a set of parameter values based at least in part on the computed statistical value, the parameter values corresponding to one or more gompertz functions; and
applying the one or more gompertz functions to the input image to obtain an output image, wherein the output image comprises one or more corrected pixel values.

2. The method of claim 1, wherein the computing comprises selecting the set of pixels from a green band of the input image, the statistical value corresponding to a mean of selected set of pixel values.

3. The method of claim 1, wherein the deriving comprises selecting a set of constant values to derive the set of parameter values such that the set of parameter values lie in a predetermined region defined by the one or more gompertz functions.

4. The method of claim 1, wherein the corrected pixel values correspond to a correction of at least one of: brightness and contrast of the output image.

5. The method of claim 3, wherein the predetermined range lies in the range of about −1 to about −5 for at least one parameter value from the set of parameter values corresponding to correction of contrast of the output image.

6. The method of claim 3, wherein the predetermined range lies in the range of about −10 to −40 for at least one parameter value from the set of parameter values corresponding to correction of brightness of the output image.

7. The method of claim 1, wherein the applying comprises rendering enhancement of shadows in the output image and highlights in the output image.

8. The method of claim 1, wherein the applying comprises normalization of the selected set of pixel values of the input image.

9. The method of claim 1, wherein the parameter values correspond to at least two gompertz functions.

10. The method of claim 9, wherein the applying comprises defining a weighted function of the at least two gompertz functions, the weighted function being so defined to assign equal weights to the at least two gompertz functions.

11. The method of claim 1, wherein the selected set of pixel values correspond to color components of color spaces comprising one or more: RGB, CMY, CMYK, RGBE, or the like.

12. The method of claim 1, further comprising:
generating a look up table storing the output pixel value subsequent to applying the one or more gompertz functions, the output pixel value computed for a range of pixel values associated with the input image.

13. The method of claim 1, further comprising
performing saturation correction on pixel values associated with the input image.

14. The method of claim 13, wherein the performing comprises: performing weighted amplification and/or weighted attenuation on the selected set of pixel values.

15. The method of claim 13, wherein the performing comprises applying an amplification factor on the selected set of pixel values to obtain the corrected pixel values, the amplification factor representing an inverted ratio of the maximum value amongst the selected set of pixel values and the corresponding pixel values subsequent to applying the one or more gompertz functions.

16. A system for correction of pixel values of an input image to compensate for variations in image capturing conditions, the system comprising:
an image analysis module configured to compute a statistical value from a selected set of pixel values associated with the input image;
a parameter setting module configured to derive a set of parameter values based at least in part on the computed statistical value, the parameter values corresponding to one or more gompertz functions; and
a generating module configured to apply the one or more gompertz functions to the input image to obtain an output image, wherein the output image comprises one or more corrected pixel values.

17. The system of claim 16, wherein the image analysis module is further configured to select the set of pixels from a green band of the input image, the statistical value corresponding to a mean of selected set of pixel values.

18. The system of claim 16, wherein the parameter setting module comprises a selection module configured to select a set of constant values to derive the set of parameter values such that the set of parameter values lie in a predetermined region defined by the one or more gompertz functions.

19. The system of claim 16, wherein the corrected pixel values correspond to a correction of at least one of: brightness and contrast of the output image.

20. The system of claim 18, wherein the predetermined range lies in the range of about −1 to about −5 for at least one parameter value from the set of parameter values corresponding to correction of contrast of the output image.

21. The system of claim 18, wherein the predetermined range lies in the range of about −10 to about −40 for at least one parameter value from the set of parameter values corresponding to correction of brightness of the output image.

22. The system of claim 16, wherein the parameter values correspond to at least two gompertz functions.

23. The system of claim 22, wherein the generating module is further configured to define a weight function of the at least two gompertz functions, the weight function being so defined to assign equal weights to the at least two gompertz functions.

24. The system of claim 16, wherein the selected set of pixel values correspond to color components of color spaces comprising one or more: RGB, CMY, CMYK, RGBE, or the like.

25. The system of claim 16, further comprising:
a look up table generating module for generating a look up table storing the output pixel value subsequent to applying the one or more gompertz functions, the output pixel value computed for a range of pixel values associated with the input image.

26. The system of claim 16, further comprising:
saturation correction module configured to perform saturation correction on pixel values associated with the input image.

27. The system of claim 26, wherein the saturation correction module is configured to apply an amplification factor on the selected set of pixel values to obtain the corrected pixel values, the amplification factor representing an inverted ratio of the maximum value amongst the selected set of pixel values and the corresponding pixel values subsequent to applying the one or more gompertz functions.

28. A computer-readable medium tangibly embodying a set of computer executable instructions for correction of pixel values of an input image to compensate for variations in image capturing conditions, the computer-executable instructions comprising modules for:
estimating a statistical value from a selected set of pixel values associated with an input image;
deriving a set of parameter values based at least in part on the estimated statistical value, the parameter values corresponding to at least two gompertz functions;
assigning weights to the at least two gompertz functions, the assigned weights so chosen to compensate for the variations in the image capturing conditions;
blending the at least two gompertz functions; and
applying the blended gompertz functions to the input image to obtain an output image comprising one or more corrected pixels.

29. The computer-readable medium of claim 28, wherein the computer executable instructions further comprises modules for selecting a set of pixels from a green band of the input image, the statistical value corresponding to a mean of the selected set of pixels.

30. The computer-readable medium of claim 28, wherein the computer executable instructions further comprises modules for selecting a set of constant values, based at least in part on the estimated statistical value, to derive the set of parameter values such that the set of parameter values lie in a predetermined region of the at least two gompertz functions

31. The computer-readable medium of claim 28, wherein the corrected pixel values correspond to a correction of one or more of: brightness and contrast of the output image.

32. The computer-readable medium of claim 28, wherein the computer executable instructions comprises modules for assigning equal weights to the at least two gompertz function.

33. The computer-readable medium of claim 28, wherein the selected set of pixel values correspond to color components of color spaces comprising one or more: RGB, CMY, CMYK, RGBE, or the like.

34. The method of claim 4, wherein the predetermined range lies in the range of about −1 to about −5 for at least one parameter value from the set of parameter values corresponding to correction of contrast of the output image.

35. The method of claim 4, wherein the predetermined range lies in the range of about −10 to −40 for at least one parameter value from the set of parameter values corresponding to correction of brightness of the output image.

36. The system of claim 19, wherein the predetermined range lies in the range of about −1 to about −5 for at least one parameter value from the set of parameter values corresponding to correction of contrast of the output image.

37. The system of claim 19, wherein the predetermined range lies in the range of about −10 to about −40 for at least one parameter value from the set of parameter values corresponding to correction of brightness of the output image.
